(19) United States
(12) Patent Application Publication
(10) Pub. No.: US 2012/0061424 A1
(43) Pub. Date: Mar. 15, 2012

(54) Cartridge piston

(76) Inventor: Manfred Obrist, Lustenau (AT)

(21) Appl. No.: 13/199,691

(22) Filed: Sep. 7, 2011

(30) Foreign Application Priority Data
Sep. 13, 2010 (EP) 10176483.5

(51) Int. Cl. B67D 7/60; G01F 11/00; B67D 7/70

(52) U.S. Cl. 222/387; 222/137; 222/386; 222/390

(57) ABSTRACT

A piston for a cartridge for storing a filler material in a storage chamber of the cartridge includes a piston body which has a conveying side as well as a drive side disposed opposite the conveying side and includes a piston jacket, wherein the piston jacket is arranged around a piston axis and the piston body is surrounded by the piston jacket at the peripheral side. The piston jacket has a sealing element for forming a fluid-tight connection between the sealing element of the piston jacket and an inner wall of the storage chamber of the cartridge so that the sealing element forms a fluid-tight connection between the conveying side and the drive side in the installed state. The piston body contains a first and a second venting element by which the conveying side and the drive side can be connected to one another by a respective bore and the piston body has a venting slit which is arranged on the conveying side.

The invention relates to a piston for a cartridge, in particular for the dispensing of filler materials containing solids, which contains a venting apparatus. The filler materials can contain multicomponent mixtures. These filler materials are introduced into a storage chamber of the cartridge. Subsequent thereto, the cartridge filled with the filler material is closed by the piston. Any air present between the piston and the filler material should exit through the venting apparatus.

Such a piston is known, for example, from DE 200 10 417 U1. The piston has a first piston part which is provided with a sealing lip. The sealing lip contacts the cartridge wall. The piston furthermore has a valve element which is configured as a second piston part. This valve element has a circular cylindrical wall part which is disposed in a recess of the first piston part and is latched at the base of this recess to the first piston part by a latch connection. The circular cylindrical wall part merges in arcuate form into a valve pin. The valve pin passes through a cylindrical bore at the first piston part and has a valve cone which is intended for contact at a valve lip of the first piston part. The latch connection is interrupted by a small air passage, whereby a filter path is formed between the wall of the first piston part and the inner side of the circular cylindrical wall part of the valve element. Further variants for such an air passage are known from EP 0351 517 A1, EP1738834 A1 or from US2005/0029306 A1.

Since a piston in accordance with DE 200 10 417 U1, EP 0351 517 A1, EP1738834 A1 or US2005/0029306 A1 is relatively complex and/or expensive to manufacture, various simplifications of this construction have been proposed. There are, for example, pistons which contain, instead of a venting valve, a bore through which air can exit.

However, these already known pistons for the dispensing of filler materials have proved to be unsuitable for the following reasons. On the one hand, there is a conflict of objectives between the size of the bore and the setting speed of these pistons. As an example, there are shown a pair of capillary passages in the document EP1338 342 A1, by which a connection between the drive side and the conveying side is obtained. The diameter of the bores forming these capillary passages has to be so small, such that a passage of the filler material from the conveying side to the drive side can be safely avoided, the capillary passages thus also form a filtering path. Accordingly the bores are referred to as capillary passages. This means that capillary forces prevent that the filler material reaches the drive side of the piston through these bores. Consequently the setting speed of the piston is small due to the fact that during the setting process of the piston it has to be ensured, that all air remaining between the filler material and the piston is discharged through the bores.

The larger the bore, the faster the air can leave the intermediate space between the piston and the filler material when the piston is inserted into the storage chamber. However, a larger bore has the consequence that a larger filler material volume can pass through this bore and the risk of contamination of the bore on the drive side of the piston is increased.

The term setting of the piston means the installation of the piston into the storage chamber of the cartridge. The storage chamber of the cartridge filled with filler material is closed in a fluid-tight manner by the piston. For this purpose, the piston is set onto the inlet opening of the cartridge and is pushed a little into this storage chamber at least so far that the drive side of the piston terminates flush with the inlet opening, in other words: no part of the piston projects beyond the inlet opening.

A further problem results during the setting of the piston in particular when viscous or pasty filler materials are used: Such a viscous or pasty filler material does not have any defined filling level in the storage chamber such as is known for a liquid which forms a meniscus. The surface of such a viscous or pasty filler material is not smooth, it has peaks and troughs. The filling level can therefore locally be substantially higher than would be expected in accordance with the mean value. The setting process of the piston, however, usually takes place in a path controlled manner. Thus, the piston is displaced along a preset path distance in the storage chamber of the cartridge. This means that the piston can come into contact with the peaks of the filler material before the piston has reached its end position. When such a peak meets the venting opening, the venting opening is blocked and an air bubble can remain between the filler material and the conveying side of the piston. If the setting process is continued, this air bubble is compressed.

Even if the filler material does not directly exit through the bore onto the drive side of the piston directing during the setting process, an entry of the filler material into the bore can consequently occur due to a slow reduction of the inner elevated pressure by the setting process. This bore is admittedly closed, for example welded, in a subsequent workstep. If, however, filler material is present in the bore, the welding procedure can be impaired or the weld can remain incomplete so that filler material can leak through the bore onto the drive side of the piston. This leak can have the effect that the storage capability of the filler material is no longer ensured.

It is the object of the invention to provide an improvement for the named piston so that filler materials can be enclosed in a fluid-tight manner in a storage chamber of a cartridge by the piston so that the filler material is storable in the cartridge for at least a limited time period. The piston should be displaceable by means of commercial dispensing units in the storage chamber of the cartridge.

This object is satisfied by a piston for a cartridge, wherein the cartridge contains at least one storage chamber for storing a filler material. The piston includes a piston body which has a conveying side as well as a drive side disposed opposite the conveying side and a piston jacket. The piston jacket is arranged about a piston axis and the piston body is surrounded by the piston jacket at the peripheral side. The piston jacket has a sealing element for forming a fluid-tight connection between the sealing element of the piston jacket and an inner wall of the storage chamber of the cartridge so that the sealing element forms a fluid-tight connection between the conveying side and the drive side in the installed state. The piston body contains a first venting element and a second venting element by which the conveying side and the drive side of the piston can be connected to one another by a respective bore and the piston body has a venting slit which is arranged on the conveying side. At least one of the bores can in particular have a circular cross-section. The bores extend through the piston body, they are situated thus in the interior of the piston body, that means the bores are not situated at an inner or outer edge of the piston body.

The provision of a first bore and of a second bore has the advantage that the venting is still ensured even when a bore is blocked by an irregular surface of the filler material during the setting process. In addition, the setting speed of the piston can be increased when a second bore is provided since the flow of air is increased when both bores are free of filler material.

A first inlet opening and a second inlet opening which open into the bore are preferably provided for at least one of the first and second venting elements. For this purpose, a respective first and second communication passage can be provided. The communication passage and/or the bore extends from the drive side to the conveying side of the piston. The first and second communication passages can in particular open into a common collection passage, with the collection passage being able to be the bore. Alternatively to this, a separate bore which connects the conveying side to the drive side can belong to each inlet opening.

The piston body has a venting slit which is arranged on the conveying side. The formation of gas bubbles which are surrounded by the piston surface on the conveying side and by the filler material can be avoided by the venting slit. The venting slit in any case provides the possibility that gas is conducted to the inlet opening of the venting element. The venting slit is in particular in connection with the first and second inlet opening.

At least one of the bores has a longitudinal axis which is aligned substantially parallel to the longitudinal axis of the piston. This variant can be manufactured particularly simply.

At least one of the inlet openings can be aligned at an angle to the longitudinal axis of the venting element. In particular the longitudinal axis of the inlet opening is arranged at an angle to the longitudinal axis of the bore of the venting element. If filler material should reach such an inlet opening, this inlet opening is not immediately blocked.

The angle is in this case larger than 10° up to and including 90°, preferably larger than 20° up to and including 90°, particularly preferably larger than or equal to 30° up to and including 90°.

A bore can furthermore contain at least one kink, a curvature or a restriction element. The path distance for a filler material entering into the bore is hereby extended. The curvatures, kinks or restricted positions form flow obstacles by which it is prevented that filler material can reach up to the drive side of the piston.

The minimal diameter of the bore is preferably larger than 1/40 of the diameter of the piston.

A piston in accordance with one of the preceding embodiments can be made as a ring piston. Such a piston includes an inner piston jacket, wherein the inner piston jacket bounds the piston body at an inner side facing the piston axis, including an inner sealing element, the piston being suitable for establishing a sealing contact with a wall of an inner tube arranged within the inner piston jacket.

The piston can be configured such that a protective element is attached to the piston body at the conveying side. Such a protective element can be made of a material which has a higher resistance with respect to the filling than the piston material. The protective element can thus develop a protective function for the piston material.

The protective element can contain a venting element. This venting element serves to remove gases of gas inclusions from the piston space which arise, for example, on the above-described setting of the piston. The gas can in particular be air.

Stiffening ribs can be arranged on the drive side of the piston. The provision of stiffening ribs ensures that the piston remains inherently stable even if the piston is put under pressure strain by means of a dispensing unit on the dispensing of the filling.

An element securing against tilting can be arranged on the drive side of the piston and serves for the improvement of the guidance of the piston within a cartridge. The piston is guided securely against tilting by the element securing against tilting which is in contact with the wall of the cartridge, that is the axis of the piston body coincides with the piston axis. It is ensured by the element securing against tilting that the conveying side is arranged in a normal plane to the piston axis or, if the conveying side is not smooth, that points of the piston surface at the conveying side which are characterized by a specific radius and a specific height are disposed in substantially the same normal plane along the periphery. If the piston were to tilt, the condition for such points would not be satisfied. A contact with the wall of the cartridge at the circumferential side can be maintained during the whole dispensing procedure by such an element securing against tilting so that a deflection of the piston can be prevented together with the previously described guide element.

The advantages of the special features which the ring piston can have correspond to the advantages such as have been listed earlier in connection with a piston for a cylindrical inner space or an inner space of a different design without installations.

A dispensing apparatus includes a piston in accordance with one of the preceding embodiments. The dispensing apparatus in particular includes a cartridge for the dispensing of a plurality of components, with the components being arranged in storage chambers of the cartridge arranged next to one another or coaxially. Furthermore, the dispensing apparatus can include a dispensing unit by means of which the piston can be connected at the drive side.

The piston in accordance with one of the preceding embodiment is particularly advantageously used for the dispensing of filler materials containing solids as well as of pasty or viscous filler materials such as sealing materials or adhesives.

The invention will be explained in the following with reference to the drawings. There are shown:

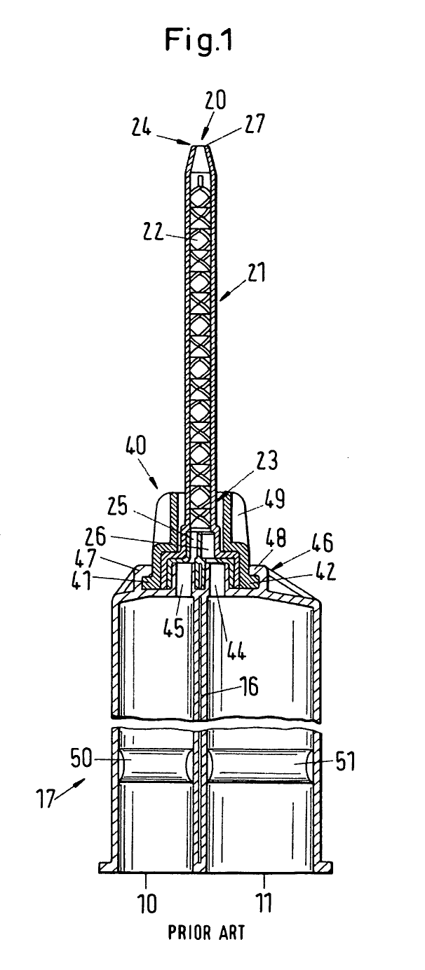

FIG. 1 a dispensing apparatus containing a respective piston in a storage chamber filled with filler material;

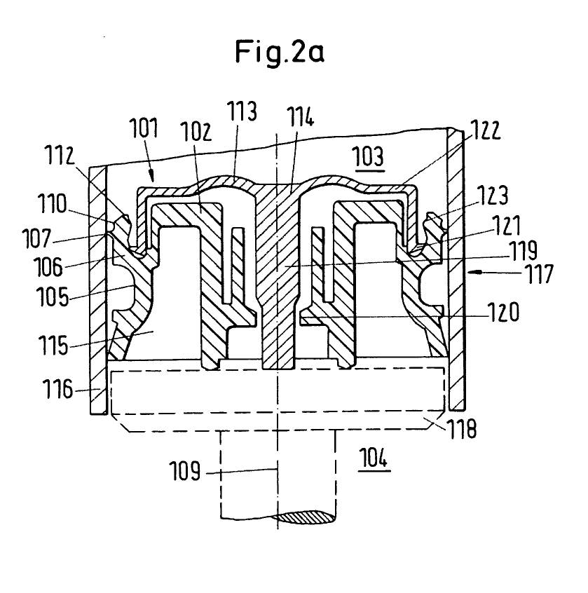

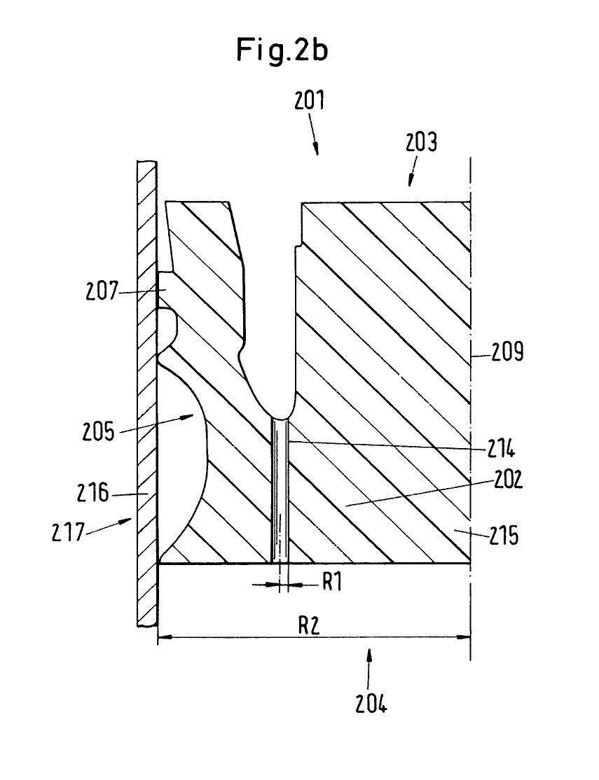

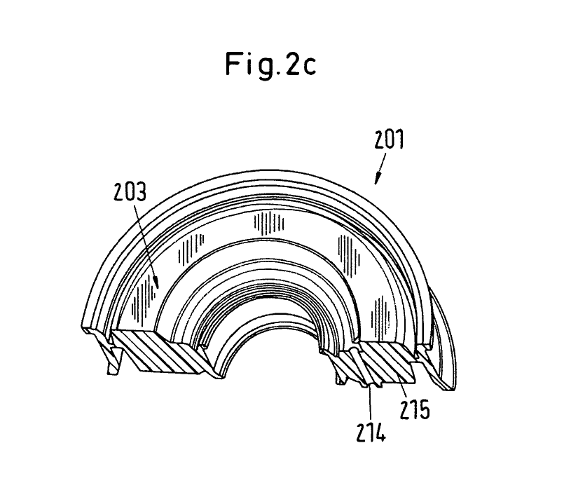

FIG. 2a a section through a piston in accordance with a first embodiment of the prior art;

FIG. 2b a section through a piston half in accordance with a second embodiment of the prior art;

FIG. 2c a section through a piston in accordance with FIG. 2b in a perspective representation;

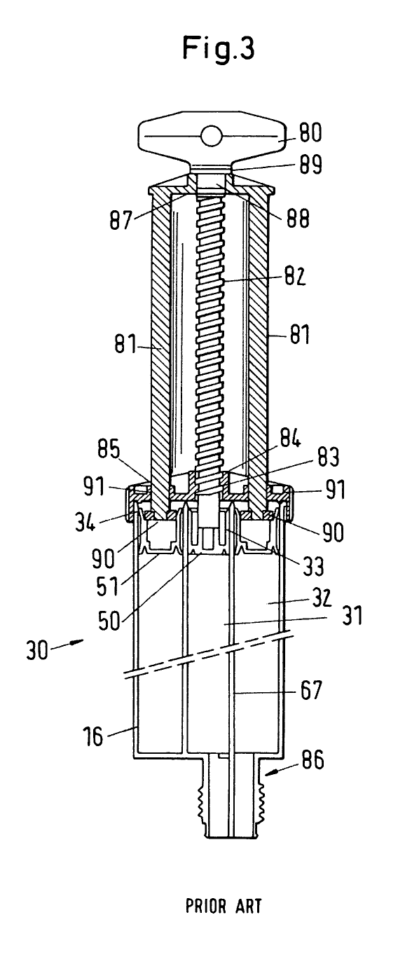

FIG. 3 a representation of a coaxial cartridge;

FIG. 4 a view of the conveying side of a piston in accordance with a first embodiment of the invention;

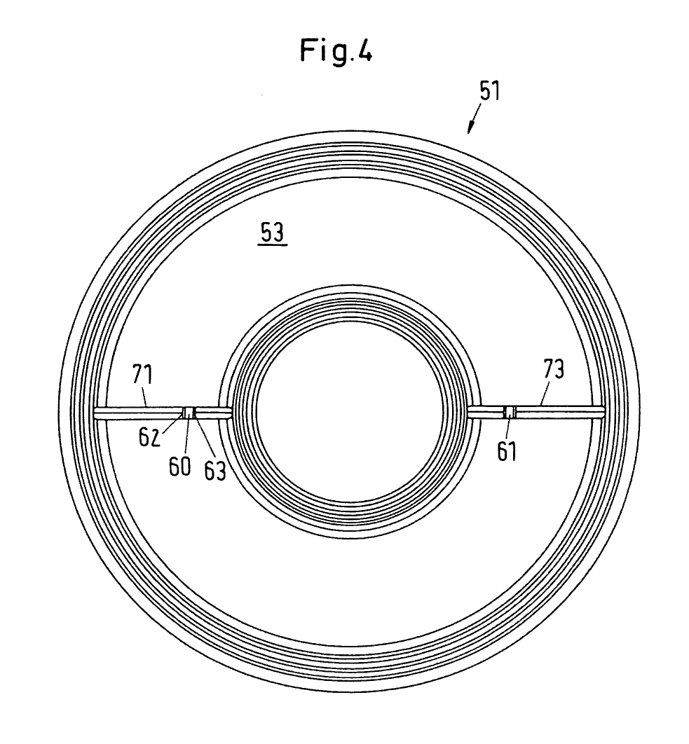

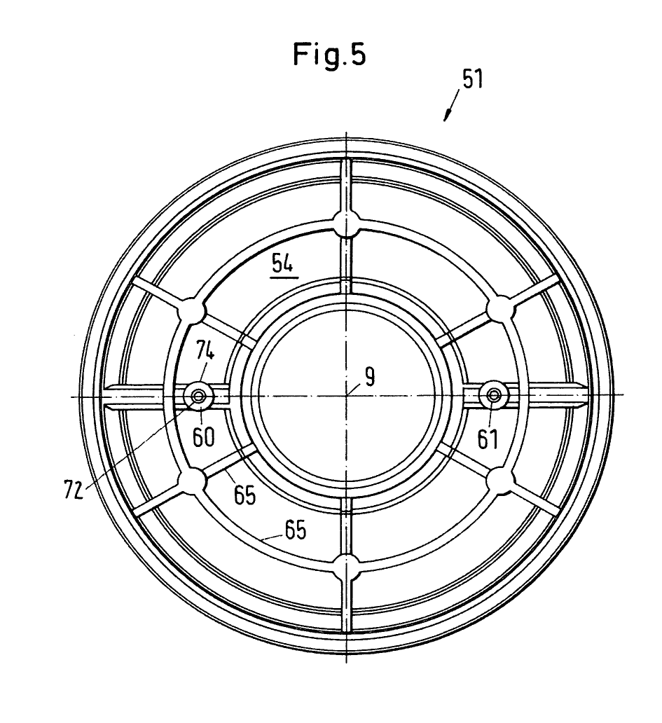

FIG. 5 a view of the drive side of the piston in accordance with FIG. 4;

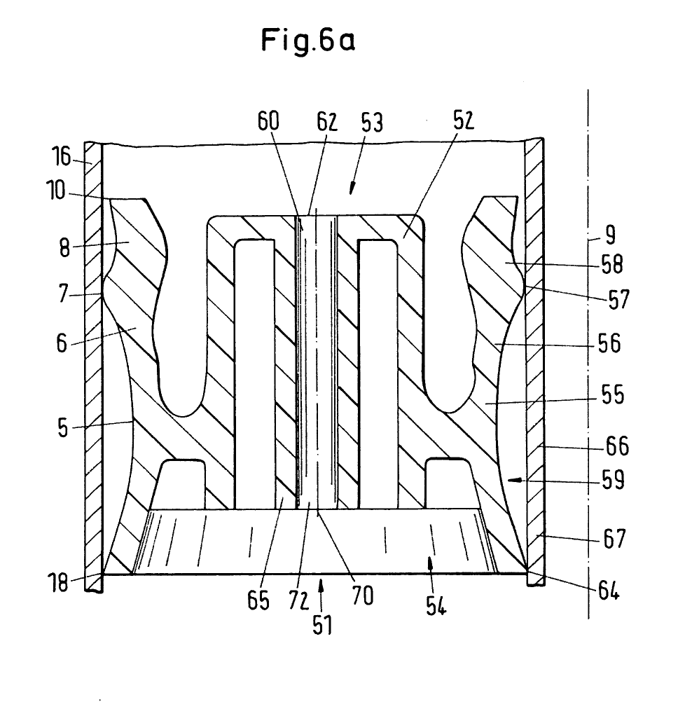

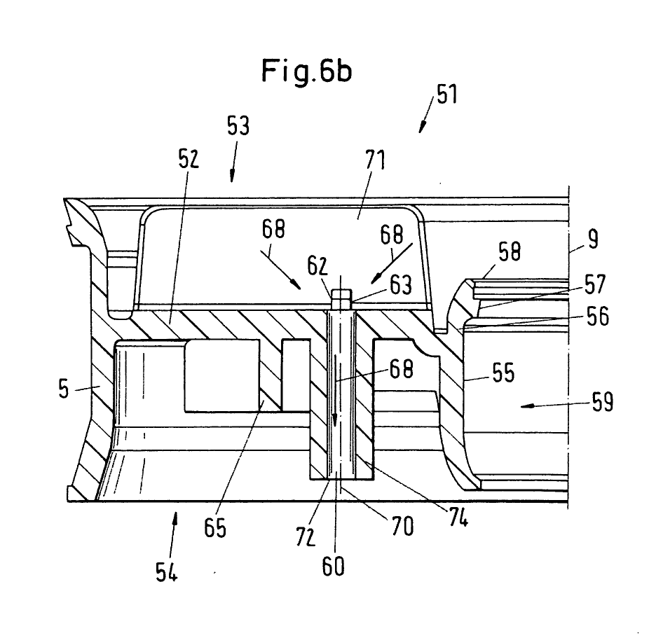

FIG. 6a a section through a piston half of the piston in accordance with FIG. 4 in a simplified embodiment;

FIG. 6b a section through a piston half of the piston in accordance with FIG. 4;

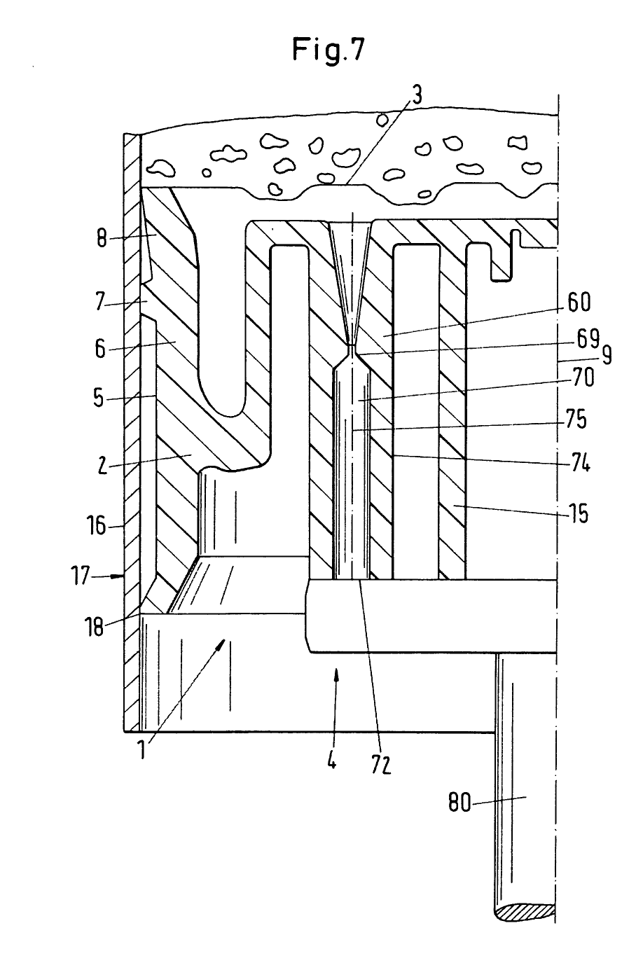

FIG. 7 a section through a piston half of a piston in accordance with a second embodiment of the invention;

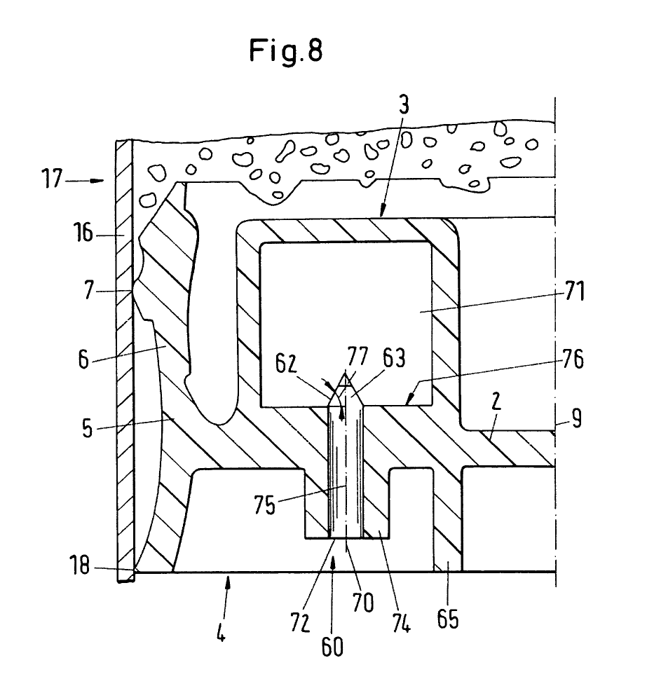

FIG. 8 a section through a piston half of a piston in accordance with a third embodiment of the invention;

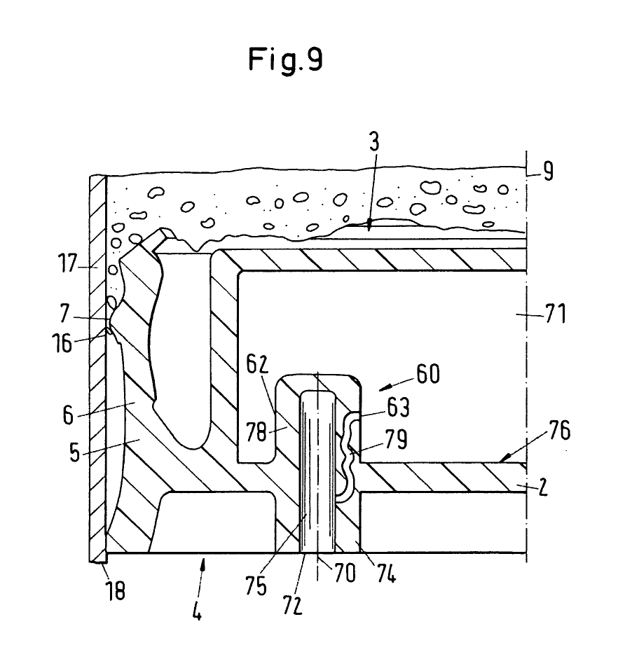

FIG. 9 a section through a piston half of a piston in accordance with a fourth embodiment of the invention; and

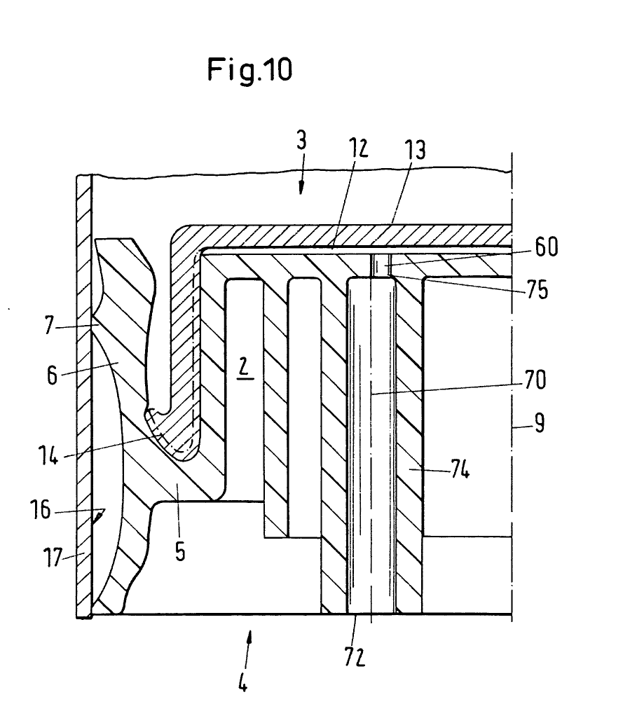

FIG. 10 a section through a piston half of a piston in accordance with a fifth embodiment of the invention.

FIG. 1 shows a dispensing apparatus which includes a cartridge 17 for dispensing a plurality of components as well as a static mixer 20 which is attached to and held on the outlet element of the cartridge.

The static mixer 20 contains a mixer housing 21 in which an arrangement of mixing elements 22 is located. The mixer housing 21 contains at its first end 23 two mutually separate inlet openings 25, 26 which are configured as stubs which can be pushed onto or into corresponding outlet openings 44, 45 of the cartridge. The second end 24 of the mixer housing 21 contains an outlet opening 27 through which the mixture can exit to be able to be supplied to the desired use. The mixer housing 21 and the arrangement of mixing elements 2 can be configured as two separate components which can optionally be moved with respect to one another.

The mixer housing 21 is connected to the outlet element 46 of the cartridge by a holding element 40, wherein the connection can be configured as a screw connection or as a bayonet connection, such as disclosed in EP 0 730 913 A1. In accordance with the embodiment of FIG. 1, a first and a second fastening element 41, 42, which are arranged at the holding element 40, engage into corresponding first and second reception elements 47, 48 of the outlet element 46. The holding element 40 is rotatable relative to the outlet element 46, wherein a rotary element 49 can be provided by means of which the holding element 40 is rotatable relative to the outlet element 46 and to the first end 23 of the mixer and the fastening elements 41, 42 can be brought into engagement with the corresponding reception elements 47, 48.

The cartridge 17 is formed as a multicomponent cartridge, wherein the components are arranged in hollow cavities of the cartridge arranged next to one another or coaxially to one another. These hollow cavities will be called storage chambers for the filler materials in the following. The storage chambers can be closed by pistons 50, 51; the outlet openings 44, 45 of the outlet element 46 can be closed by a closure cap, which is not shown in the drawings, or by a static mixer which is already blocked by hardened mixing material.

The pistons 50, 51 are movable along the wall 16 of the corresponding storage chamber. The pistons are introduced through inlet openings 10, 11 into the storage chambers. The process of introducing the pistons into the storage chambers filled with filler material is called setting the piston.

The invention can naturally be used in the same manner for pistons for single-component cartridges and for coaxial cartridges.

FIG. 2a shows a piston such as is known from the prior art from DE 200 10 417 U1. The piston 101 includes a piston body 102 which is usually manufactured by means of an injection molding process from plastic. The piston 101 is preferably used to dispense a filler material, in particular of fluid or pasty media, from a cartridge. A wall 116 of the cartridge 117 is shown. The piston 101 slides along the wall 116 and, in this movement, expels the filling through an outlet opening of the cartridge, which is not shown in the drawings. The side of the piston 101 at the media side will be called the conveying side 103 in the following. To set the piston into motion and to keep it in motion, a compressive force is applied by means of a dispensing unit. The dispensing unit, of which a plunger element 118 is shown, is located on the side of the piston which is disposed opposite the conveying side 103. This side will be called the drive side 104 in the following.

The piston body 102 is thus bounded by the drive side 104, the conveying side 103 as well as by a piston jacket 105. The piston jacket 105 forms the connection between the drive side 104 and the conveying side 103. In most cases, the piston body has a plurality of cut-outs or is made as a hollow body. Such pistons are already made as thin-walled components from diameters of a few centimeters for reasons of saving material as well as due to the difficulties resulting from the injection molding of thick-walled components. The piston receives the required shape stability or rigidity through stiffening ribs 115. The piston can additionally contain a protective element 113. A protective element 113 can be made as a cover plate whose function consists of screening the piston body from the filling. A cover plate is used when the filler material is prone to attacking the piston material. This applies in particular to pistons of soft plastic such as LDPE. LDPE is attacked, for example, by polyester resins and swells up.

The piston can also contain a venting element. Such a venting element 114 is shown in FIG. 1. Gas which is located in the storage chamber of the cartridge 117 between the filler material and the piston 101 can escape to the outside through this venting element, that is to the drive side 104, without any leakage of the filler material. The venting element 114 is closed as long as the cartridge is stored in the filled state. This means that the pin 119 of the venting element 114 lies on the corresponding seat 120.

If the filler material should be dispensed, the dispensing unit 118 is brought into contact with the piston 101 on its drive side 104. In this respect, the dispensing unit also comes into contact with the end of the pin 119 of the venting element 114. The end of the pin 119 projects beyond the surface which enters into contact with the dispensing unit on the drive side so that the pin lifts off its seat 120 when the dispensing unit 118 comes into contact with the drive side 104. A flow path for the gas is opened in this respect. The gas enters via the flanks 121 of the valve body 122 formed as a cover plate into the intermediate space between the valve body 122 and the piston body 102 and leaves the piston via the opened flow path through the opening between the pin 119 and the seat 120.

The flanks 121 are in engagement with the piston body 102 via latch connections. For this purpose, the flank 121 engages, for example, into a circumferential groove 123 of the piston body 102 on the conveying side 103. The flank can also have a sealing lip which engages into a cut-out of a projection 106 of the piston 101. A plurality of small cut-outs are usually provided in the flank for the gas. A labyrinthine connection path can be provided between the piston body 102 and the cover plate 113 subsequent to these cut-outs. Filler material passing through the cut-outs can thus be deposited along this labyrinthine connection path. This connection path is not shown in any more detail in the drawing.

The piston 101 has means against the outlet of filler material at the drive side 104. For this purpose, at least one sealing lip is usually provided along the sliding surface at the wall 116 of the cartridge. The sealing lip 107 is located at a projection 106 which extends between the groove 123 and the wall 116 of the cartridge. The projection 106 is formed as an arm which is in connection with the piston body 102. This arm belongs to a ring-shaped bead which extends along the total periphery of the piston body 102 and forms a fluid-tight connection with the wall 116 of the cartridge 117.

FIG. 2b shows a section through a piston half of a piston 201 in accordance with a second embodiment of the prior art. A piston half of this piston is also shown in FIG. 2c. The piston 201 includes a piston body 202 which is usually manufactured by means of an injection molding process from plastic. The piston 201 is used to dispense a filler material, in particular of fluid or pasty media, from a cartridge. A wall 216 of the cartridge 217 is shown. The piston 201 slides along the wall 216 and, in this movement, expels the filler material through an outlet opening of the cartridge, not shown. To set the piston into motion and to keep it in motion, a compressive force is applied by means of a dispensing unit, which can be formed similarly to FIG. 2a.

The piston body 202 is thus bounded by the drive side 204, the conveying side 203 as well as by a piston jacket 205. The piston jacket 205 forms the connection between the drive side 204 and the conveying side 203. In most cases, the piston body as in FIG. 2a has a plurality of cut-outs or is configured as a hollow body. The section of FIG. 2b and also of FIG. 2c is laid through a radially extending stiffening rib 215 of the piston.

The piston contains a venting element 214 which is configured as a bore. Gas which is located in the storage chamber of the cartridge 217 between the filler material and the piston 201 can escape to the outside through this venting element 214, that is to the drive side 204, without the filler material exiting if the bore has a sufficiently small diameter. A bore having a small diameter, however, has the consequence of a correspondingly high pressure loss so that the setting speed of the piston is correspondingly small. The radius of the bore will in this respect be designated by R1, the piston radius by R2. The distance from the piston axis 209 up to the end of the sealing lip 207 which corresponds to the inner radius of the storage chamber of the cartridge is selected as the piston radius R2. In the present embodiment in accordance with FIG. 2c, the ratio of R1/R2 is at 1/45.

FIG. 3 is a representation of a coaxial cartridge 30. In a coaxial cartridge, two or more cylindrical storage chambers 31, 32 arranged coaxially to one another are arranged for one respective component of the filler material. The inner storage chamber 31 is completely surrounded by the outer storage chamber 32. The outer storage chamber 32 is arranged in ring shape about the inner storage chamber 31. The outer boundary of the outer storage chamber is formed as a cylindrical cartridge wall 16. The inner storage chamber 31 is bounded by an inner tube 67. The inner and outer storage chambers each contain a piston 50, 51. The inner piston 50 is located in the inner storage chamber 31; the ring piston 51 in the outer storage chamber 32.

Furthermore, a dispensing unit 80 is shown by means of which the inner piston 50 and the ring piston 51 can be moved simultaneously. The dispensing unit contains a ring-shaped plunger 81 for moving the ring piston 51 as well as an inner plunger 82 for moving the inner piston 50. The inner plunger 82 in this embodiment has an external thread 83 which is in engagement with an internal thread 84 which is part of an attachment element 85. This attachment element 85 is set onto the inlet openings 33, 34 of the cartridge and remains connected thereto in a fixed-position as long as the filler material contained in the storage chambers 31, 32 is being dispensed.

The attachment element is connected to the cartridge in a fixed position. By a rotary movement of the inner plunger 82, it is moved relative to the inner thread 84 so that the inner piston 50 in the storage chamber 31 is displaced in the direction of the outlet element 86 of the cartridge. The outer plunger 81 has a head end 87 which is rotatably supported on a contact surface 88 adjoining the external thread 83. An abutment 89 prevents a displacement of the outer plunger 81 relative to the inner plunger 82. The outer plunger 81 has a foot end 90 which lies on the ring piston 51. The foot end 90 advantageously has a ring-shaped contact surface. A guide element which is conducted through a bore 91 of the attachment element 85 extends between the head end 87 and the foot end 90. The ring piston 51 and the inner piston 50 can thus be displaced simultaneously.

FIG. 4 shows a view of the conveying side 53 of a piston in accordance with a first embodiment of the invention which is used, for example, in a coaxial cartridge in accordance with FIG. 34 as a ring piston 51. A first and a second venting element 60, 61 are in particular shown. Since the piston has two or more venting elements, the volume flow can even be doubled with the same diameter of the venting element as in the prior art. This means that the setting speed of the piston can be increased accordingly. Surprisingly, there is in this respect no passing through of filler material to the drive side of the piston. Each of the venting elements is arranged in a venting slit 71, 73. This means that the filler material has to penetrate into the narrow venting slit and move up to the inlet opening of the venting element. The inlet opening 62, 63 of the venting element is advantageously arranged at an angle to the surface of the piston on the conveying side 53.

The venting slit, in addition to a function as a restrictor element for the filler material, also has the function of detecting gas inclusions at each point of the associated piston half and of enabling the transport of the gas to the corresponding inlet opening 62, 63. In particular when the filler material is viscous, it does not form a defined surface. The surface of the filler material can contain peaks and troughs. If such a peak were by chance directly to meet the inlet opening of the venting element, a blocking of the venting element could occur. If such a peak, however, meets a venting slit, the gas can flow past the point of impact of the peak tip of the filler material through the venting slit 71, 73 into the corresponding inlet opening, as is shown in detail in FIG. 6b. The arrows 68 in this respect designate the flow path of the gas.

FIG. 5 shows a view of the drive side 54 of the piston 51 in accordance with FIG. 4. The two venting elements 60, 61 lie opposite one another in mirror-symmetrical arrangement with respect to a plane extending vertically through the longitudinal axis 9 of the piston in the drawing. They do not lie on the radially and axially extending stiffening ribs 65, but rather in an intermediate space between these stiffening ribs. None of the venting slits 71, 73 shown in FIG. 4 coincides with the stiffening ribs.

FIG. 6a shows a section through a piston half of the piston in accordance with FIG. 4. The ring piston 51 includes a piston body 52 which is usually manufactured by means of an injection molding process from plastic. The ring piston 51 is preferably used to dispense a filler material, in particular of fluid or pasty media, from a coaxial cartridge for which a possible construction is shown in FIG. 3. A wall 16 of the cartridge is shown. The ring piston 51 slides along the wall 16 and, during this movement, expels the filler material through an outlet opening, which is not shown in the figure, arranged in the outlet element 86 (see FIG. 3). The side of the piston 51 at the media side will be called the conveying side 53 in the following. To set the piston into motion and to keep it in motion, a compressive force is applied by means of a dispensing unit. The dispensing unit, which is not shown here, is located on the side of the piston which is disposed opposite the conveying side 53. This side will be called the drive side 54 in the following.

The piston body 52 is thus bounded by the drive side 54, by the conveying side 53 as well as by an outer piston jacket 5 and an inner piston jacket 55. The outer piston jacket 5 can have the same structure as is described in the following with respect to FIG. 7 to FIG. 10 for a simple piston 1. The inner piston jacket 55 forms the inner connection between the drive side 54 and the conveying side 53. The inner piston jacket 55 bounds the piston body 52 at an inner side 59 facing the piston axis 9.

The inner piston jacket 55 merges on the conveying side 53 into a projection 56. The projection 56 in the embodiment is a thin-walled rotationally symmetrical body which is visible in the sectional representation as an arm of the piston body 52. The projection 56 has an inner guide element 57 for guiding the piston along an inner tube 67 of the cartridge. The guide element 57 is suitable for the establishment of a sealing contact with a wall 66 of the inner tube 67. The guide element 57 can in particular be made as a sealing lip. If required, a plurality of sealing lips can also be provided. The projection 56 includes a scraper element 58 which has a smaller spacing from the conveying side 53 than the guide element 57.

The ring piston contains a first and a second venting element 60, 61, wherein the second venting element is not shown in the drawing in FIG. 6a. In its simplest embodiment, the venting element 60 is formed as a bore which reaches from the conveying side 53 of the piston to its drive side 54. In accordance with the embodiment shown in FIG. 6a, the venting element has a longitudinal axis 70 which extends substantially parallel to the longitudinal axis 9 of the piston. The venting element 60 has an inlet opening 62 as well as an outlet opening 72. Gas, in particular air, which has collected between the filler material and the piston surface on the conveying side 53 can enter into the bore through the inlet opening and is conducted through the bore in the direction of the outlet opening 72. This variant is in particular suitable for filler materials which form a substantially smooth surface.

If two or more venting elements are distributed over the piston body 52, local gas inclusions can be avoided. Even if a venting element should clog prematurely because filler material moves through its inlet opening 62, at least one further venting element is still available to the gas.

The piston body has stiffening ribs 65. The venting element can be a component of such a stiffening rib, which is shown in FIG. 6a. The outlet opening 72 of the venting element is accordingly arranged on a stiffening rib, whereby the position of this outlet opening can be exactly fixed. If the outlet opening should be closed after the end of the setting process, it can be welded in a simple manner. The position of the outlet opening is exactly fixed and a distortion of the piston can be prevented by the heat effect during the welding process since the stiffening rib acts analogously to a fixed mounting for the outlet opening.

In addition, the piston in accordance with FIG. 6a has an outer and an inner element securing against tilting 18, 64 so that the piston cannot tilt, whereby the piston is stabilized in its position relative to the wall 16 of the cartridge.

FIG. 6b shows a section through a piston half of the piston in accordance with FIG. 4 in which the bore for the venting element 60 differs from the bore in accordance with FIG. 6a. The venting element contains a first and a second inlet opening 62, 63 in addition to the bore which connects the conveying side 53 to the drive side 54.

The venting element 60 shown in FIG. 6b is disposed next to the stiffening ribs 65. A radially extending stiffening rib is shown in FIG. 6b which is arranged outside the venting element 60. The stiffening rib 65 thus has a larger spacing from the piston axis 9 than the longitudinal axis 70 of the venting element. The venting element is formed as a stub 74 which projects beyond the stiffening ribs on the drive side 54. The larger construction length of the venting element facilitates the accessibility for a welding tool by means of which the outlet opening 72 is closed after terminating the setting of the piston. The closing is necessary to prevent an outlet of filler material when the cartridge is supported such that the piston does not adopt the highest position. In addition, it can be necessary with individual filler materials that they do not come into contact with air during the storage because hereby chemical reactions can occur which can change the properties of the filler material to an unwanted degree.

It is in addition advantageous if the stub has a length which is as large as possible since the passage formed by the bore is hereby extended. If filler material should actually reach one of the inlet openings, the period until the filler material would reach the outlet opening can be extended. It can be expected that it occurs with viscous filler materials which do not have any defined filling level, but rather form a surface made up of peaks and troughs, that this filler material penetrates into the venting slit and moves up to the inlet opening 62, 63. The setting process is therefore terminated before the outlet opening is actually reached. The outlet opening 72 can therefore be welded without a contamination of the same with filler material having to be feared. If the filler material is namely viscous, the flow speed thereof is also so low on a pressure equalization possibly taking place subsequent to the setting process that the workstep of the welding is already terminated before filler material could exit the outlet opening. Contamination of the outlet opening can thus be avoided by the embodiment shown in FIG. 6b. The outlet opening can accordingly be welded in a fluid-tight manner so that the filled cartridge can be stored in any desired position over longer time periods.

FIG. 7 shows a piston 1 which can be used for a single-component cartridge, as an inner piston 50 for a coaxial cartridge or as one of the pistons 50, 51 of a two-component cartridge with storage chambers lying next to one another, as shown in FIG. 1. The piston 1 includes a piston body 2 which is usually manufactured by means of an injection molding process from plastic.

A wall 16 of the cartridge 17 is shown. The ring piston 1 slides along the wall 16 and, in this movement, expels the filler material through an outlet opening 44, 45, not shown, arranged in the outlet element 46 (see FIG. 1) or through an outlet opening arranged in the outlet element 86 (see FIG. 3). The side of the piston 1 at the media side will be called the conveying side 3 in the following. To set the piston into motion and to keep it in motion, a compressive force is applied by means of a dispensing unit. The dispensing unit, which is not shown here, is located on the side of the piston which is disposed opposite the conveying side 3. This side will be called the drive side 4 in the following.

The piston body 2 is thus bounded by the drive side 4, the conveying side 3 as well as by a piston jacket 5. The piston jacket 5 can have the same structure as the outer piston jacket of FIGS. 6 to 6b.

The piston jacket 5 merges on the conveying side 3 into a projection 6. The projection 6 in the embodiment is a thin-walled rotationally symmetrical body which is visible in the sectional representation as an arm of the piston body 2. The projection 6 has an inner guide element 7 for guiding the piston along a wall 16 of the cartridge. The guide element 7 is suitable for the establishment of a sealing contact with a wall 16 of the storage chamber of the cartridge 17. The guide element 7 can in particular be made as a sealing lip. If required, a plurality of sealing lips can also be provided. The projection 6 includes a scraper element 8 which has a smaller spacing from the conveying side 3 than the guide element 7.

The piston 1 contains a first and a second venting element 60, 61, wherein the second venting element is not shown in the drawing in FIG. 7. The venting element 60 has a longitudinal axis 70 which extends substantially parallel to the longitudinal axis 9 of the piston. Gas, in particular air, which has collected between the filler material and the piston surface on the conveying side 3 can enter into a bore 75 through an inlet opening 62 and is conducted through the bore 75 in the direction of the outlet opening 72.

A communication between the conveying side 3 of the piston and its drive side 4 is formed by the bore 75. The diameter of the bore can vary; for example, the diameter can decrease as the spacing from the conveying side increases. In accordance with FIG. 7, a conical shape is obtained by the variation of the diameter. The bore 75 forms a restriction element 69 at the narrowest point. If filler material should move up to the restriction element, it represents an obstacle for the filler material so that the discharge of filler material to the drive side 4 of the piston is delayed at least until the end of the bore at the conveying side, its outlet opening 72, has been closed in a subsequent workstep, for example by a plug or by welding.

Subsequent to the restriction element 69, the bore of the venting element can widen again so that any filler material passing through the restriction element can be deposited in the bore preventing that filler material moves into the vicinity of the outlet opening 72.

The venting element has a stub 74. The stub 74 has substantially the same length as the stiffening rib 15 so that the stub 74 can serve as a support for a dispensing unit 80.

If two or more venting elements are distributed over the piston body 2, local gas inclusions can be avoided. Even if a venting element should clog prematurely because filler material passes through its inlet opening 62, at least one further venting element is still available to the gas so that a gas inclusion between the filler material and the conveying side of the piston is avoided.

In FIG. 8, a piston 1 is shown having a variant of the venting element 60 which substantially corresponds to the venting element which is shown for a ring piston in FIG. 4, FIG. 5 and FIG. 6b.

The piston 1 includes a piston body 2 which has a conveying side 3, a drive side 4 disposed opposite the conveying side 3 and a piston jacket 5, wherein the conveying side 3 and the drive side 4 are surrounded by the piston jacket 5 at the peripheral side. The piston 1 is preferably a plastic component which has advantageously been manufactured in an injection molding process. The piston jacket 5 forms a connection between the conveying side 3 and the drive side 4, with the piston jacket 5 being arranged about a piston axis 9. The piston jacket is in particular formed as a rotationally symmetrical body when the piston is intended for reception in a cylindrical cartridge. The piston jacket 5 merges on the conveying side 3 into a projection 6. The projection 6 in the embodiment is a thin-walled rotationally symmetrical body which is visible in the sectional representation as an arm of the piston body 2. The projection 6 has a guide element 7 for the conducting of the piston in a cartridge 17 which is suitable for establishing a sealing contact to a wall 16 of the cartridge 17. The guide element can in particular be configured as a sealing lip. If required, a plurality of sealing lips can also be provided.

An element securing against tilting 18 can be arranged on the drive side 4 of the piston and serves for the improvement of the guidance of the piston in a cartridge. The piston is guided securely against tilting by the element securing against tilting 18 which is in contact with the wall 16 of the cartridge 17, that is the axis of the piston body 2 coincides with the piston axis 9. It is ensured by the element securing against tilting 18 that the conveying side 3 is arranged in a normal plane to the piston axis 9 or, if the conveying side 3 does not contain any smooth surface or contains sections which do not lie in one plane, that points of the piston surface at the conveying side which are characterized by a specific radius and a specific height are disposed in substantially the same normal plane along the circumference. If the piston 1 were to tilt, the condition for such points would no longer be satisfied. A contact with the wall 16 of the cartridge at the circumferential side can be maintained during the whole dispensing procedure by such an element securing against tilting 18 so that a deflection of the piston can be prevented together with the previously described guide element 7.

The venting element 60 shown in FIG. 8 is disposed next to the stiffening ribs 65. A radially extending stiffening rib 65 is arranged on a radius which is smaller than the radius belonging to the venting element 60, that is the stiffening rib 65 has a smaller spacing from the piston axis 9 than the longitudinal axis 70 of the venting element. The venting element 60 has a bore 75 which connects the conveying side 3 of the piston to the drive side 4. The gas passes into the bore 75 via two inlet openings 62, 63. The inlet openings are arranged at an angle to the piston surface. The piston surface in this embodiment is the slit base 76 of a venting slit 71 which can be configured as in FIG. 4, FIG. 5 or FIG. 6b. The slit base 76 lies in a normal plane to the piston axis 9. The angle 77 between the slit base and the inlet plane of the inlet opening is preferably larger than 0° and can be up to 90°.

The venting element has a stub 74 which projects beyond the stiffening ribs on the drive side 4. The larger construction length of the venting element facilitates the accessibility for a welding tool by means of which its outlet opening 72 is closed after terminating the setting of the piston. The closing is necessary to prevent an outlet of filler material when the cartridge is stored such that the piston does not adopt the highest position. In addition, it can be necessary with individual filler materials that they do not come into contact with air during the storage because chemical reactions of the filler material with the air can occur.

It is in addition advantageous if the stub 74 has a length which is as large as possible since the passage formed by the bore is hereby extended. If filler material should actually reach one of the inlet openings 62, 63, the period up to which the filler material would reach the outlet opening can be extended. It can be expected that it at best occurs with viscous filler materials which do not have any defined filling level, but rather form a surface made up of peaks and troughs. This filler material additionally penetrates into the venting slit and can move up to the inlet opening 62, 63. The setting process is therefore terminated before the outlet opening is actually reached. The outlet opening 72 can therefore be welded without a contamination of the same with filler material having to be feared. If the filler material is namely viscous, the flow speed thereof is also so low on a pressure equalization possibly taking place subsequent to the setting process that the workstep of the welding is already terminated before filler material could exit the outlet opening. Contamination of the outlet opening can thus be avoided by the embodiment shown in FIG. 8. The outlet opening can accordingly be welded in a fluid-tight manner so that the filled cartridge can be stored in any desired position over longer time periods.

FIG. 9 shows a variant of the piston 1 having a venting slit 71 traversing the total piston body 2. Parts of the piston 1 of the same function as in FIG. 8 have the same reference numerals. The venting element 60 has labyrinthine passages 78, 79 which connect the inlet openings 62, 63 to the bore 75. These labyrinthine passages form a filter path in which filler material can be deposited. It is hereby avoided that filler material can enter up to the outlet opening 72.

FIG. 10 shows a variant of a piston 1 for filler materials which are prone to chemically change the plastic of the piston. The piston 1 includes a piston body 2 which has a conveying side 3, a drive side 4 disposed opposite the conveying side 3 as well as a piston jacket 5 and a protective element 13. The piston jacket 5 connects the conveying side 3 and the drive side 4 and represents the boundary to the wall 16 of the cartridge 17.

The protective element 13 is formed as a cover plate and covers the piston body 2 so that the piston body of the filler is not exposed. The protective element 13 or the piston body 2 has a venting passage 14 along which gas can be conducted past the protective element into an intermediate space 12. The intermediate space 12 extends at least partly between the piston body 2 and the protective element 13. From the intermediate space 12, the gas moves into the venting element 60 which is here formed as a simple bore 75. This bore opens into a stub 74 formed with a further bore. The stub 74 has an outlet opening 72 which can in turn be closed after ending the setting of the piston.

The variants of the venting elements shown in FIG. 7 to FIG. 10 can naturally also be used for a ring piston 51 in accordance with one of the FIGS. 4 to 6b.

What is claimed is:

1. A piston for a cartridge for storing a filler material in a storage chamber of the cartridge, including a piston body which has a conveying side as well as a drive side disposed opposite the conveying side and including a piston jacket, wherein the piston jacket is arranged around a piston axis and the piston body is surrounded by the piston jacket at the peripheral side, wherein the piston jacket has a sealing element for forming a fluid-tight connection between the sealing element of the piston jacket and an inner wall of the storage chamber of the cartridge so that the sealing element forms a fluid-tight connection between the conveying side and the drive side in the installed state, characterized in that the piston body contains a first and a second venting element by which the conveying side and the drive side can be connected to one another by a respective bore and the piston body has a venting slit which is arranged on the conveying side.

2. A piston in accordance with claim 1, wherein, for at least one of the first or second venting elements, a first inlet opening and a second inlet opening are provided which open into the bore so that gas can be conducted from the front side to the drive side.

3. A piston in accordance with claim 1 wherein a first and a second bore are provided.

4. A piston in accordance with claim 1 wherein said venting slit is in connection with the first and second inlet opening.

5. A piston in accordance with claim 1 wherein at least one of the bores has a longitudinal axis which is aligned substantially parallel to the longitudinal axis of the piston.

6. A piston in accordance with claim 1 wherein at least one of the inlet openings is aligned at an angle to the longitudinal axis of the venting element.

7. A piston in accordance with claim 6, wherein the angle is larger than 10° up to and including 90°, preferably larger than 20° up to and including 90°, particularly preferably larger than or equal to 30° up to and including 90°.

8. A piston in accordance with claim 1 wherein the bore contains at least one kink.

9. A piston in accordance with claim 1 wherein the bore contains at least one curvature.

10. A piston in accordance with claim 1 wherein the bore contains at least one restriction element.

11. A piston in accordance with claim 1 wherein the minimal diameter of the bore is larger than 1/40 of the diameter of the piston.

12. A piston in accordance with claim 1 including an inner piston jacket, wherein the inner piston jacket bounds the piston body at an inner side facing the piston axis, including an inner sealing element, which is suitable for establishing a sealing contact with a wall of an inner tube arranged within the inner piston jacket.

13. A piston in accordance with claim 1 wherein stiffening ribs are arranged on the drive side for connecting the piston jacket to the piston body and/or an element securing against tilting is arranged.

14. A dispensing apparatus including a piston in accordance with claim 1.

15. A dispensing apparatus in accordance with claim 14, including a cartridge for dispensing a plurality of components, wherein the components are arranged in storage chambers of the cartridge arranged next to one another or coaxially.
